(19) United States
(12) Patent Application Publication
(10) Pub. No.: US 2019/0265481 A1
(43) Pub. Date: Aug. 29, 2019

(54) METHOD, DEVICE, AND STORAGE MEDIUM FOR VIRTUAL REALITY DISPLAY

(71) Applicant: Shanghai Xiaoyi Technology Co., Ltd., Shanghai (CN)

(72) Inventor: Bin SUN, Shanghai (CN)

(73) Assignee: Shanghai Xiaoyi Technology Co., Ltd., Shanghai (CN)

(21) Appl. No.: 16/284,638

(22) Filed: Feb. 25, 2019

(30) Foreign Application Priority Data
Feb. 26, 2018 (CN) 201810159629.9

(51) Int. Cl. G02B 27/01; G02B 5/04; H04N 13/344

(52) U.S. Cl. CPC G02B 27/0172; G02B 5/04; G02B 2027/014; G02B 2027/0132; G02B 2027/0178; H04N 13/344

(57) ABSTRACT

Virtual reality display methods and virtual reality glasses are disclosed. According to some disclosed embodiments, the method includes: receiving video data to be displayed; separately presenting the video data on a left eye display screen and a right eye display screen; and separately reflecting an image on the left eye display screen to a user's left eye and an image on the right eye display screen to the user's right eye by using two prisms.

### CROSS-REFERENCE TO RELATED APPLICATION

The disclosure claims the benefits of priority to Chinese Application No. 201810159629.9, filed on Feb. 26, 2018, which is incorporated herein by reference in its entirety.

### FIELD OF TECHNOLOGY

The present disclosure relates to the field of virtual reality technology, and more particularly, to a virtual reality display method and virtual reality glasses.

### BACKGROUND OF THE DISCLOSURE

With the development of virtual reality (VR) technology, virtual reality devices, such as virtual reality glasses, are being employed by more and more users. By employing virtual reality glasses to view a video, a user may gain an immersive experience.

In currently available technology, virtual reality glasses, such as Google Cardboard, are normally realized using two convex lenses. A play device is disposed in the virtual reality glasses so that a video can be viewed. In order to obtain a broader field of view, the distance between a user's eyeballs and the lenses needs to be shortened, or the size of the lenses needs to be increased, and the lenses may form virtual images for the user to view without becoming out of focus.

However, due to enlargement by a convex lens, a video image enlarged by a convex lens is highly grainy, resulting in an inadequately detailed image and poor user experience.

### BRIEF SUMMARY OF THE DISCLOSURE

The technical problem addressed by the present disclosure is to enhance the clarity of images on virtual reality displays and improve the virtual reality experience of users.

In order to address the aforementioned technical problem, one exemplary embodiment of the present disclosure provides a virtual reality display method, the virtual reality display method comprising: receiving video data to be displayed; separately presenting the video data on a left eye display screen and a right eye display screen; and separately reflecting an image on the left eye display screen to a user's left eye and an image on the right eye display screen to the user's right eye by using two prisms.

In some embodiments, the number of pixels on the left eye display screen and the number of pixels on the right eye display screen are greater than a preset threshold value.

In some embodiments, the sizes of the reflective surfaces of the prisms and the sizes of the left eye display screen and the right eye display screen are all the same.

In some embodiments, the receiving video data to be displayed includes: receiving the video data by means of short-range wireless communication.

In some embodiments, the left eye display screen and the right eye display screen are molecular organic light-emitting diode displays.

In order to address the aforementioned technical problem, one exemplary embodiment of the present disclosure further discloses virtual reality glasses, the virtual reality glasses comprising: a processor configured to receive video data to be displayed; a left eye display screen and a right eye display screen configured to separately display the video data; and two prisms configured to separately reflect an image on the left eye display screen to a user's left eye and an image on the right eye display screen to the user's right eye.

In some embodiments, the number of pixels on the left eye display screen and the number of pixels on the right eye display screen are greater than a preset threshold value.

In some embodiments, the sizes of the reflective surfaces of the prisms and the sizes of the left eye display screen and the right eye display screen are all the same.

In some embodiments, the left eye display screen and the right eye display screen are molecular organic light-emitting diode displays.

In some embodiments, the virtual reality glasses include a wireless communication module configured to receive the video data by means of short-range wireless communication.

In some embodiments, the processor converts the video data into a format configured to be displayed on the left eye display screen and the right eye display screen.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 is a flowchart illustrating a virtual reality display method, according to an exemplary embodiment of the present disclosure;

FIG. 2 is a block diagram illustrating the result of a set of virtual reality glasses, according to an exemplary embodiment of the present disclosure;

FIG. 3 is a block diagram illustrating the result of another set of virtual reality glasses, according to an exemplary embodiment of the present disclosure;

FIG. 4 is a block diagram illustrating the result of yet another set of virtual reality glasses, according to another exemplary embodiment of the present disclosure.

### DETAILED DESCRIPTION OF THE DISCLOSURE

As stated in the Background of the Disclosure section, due to enlargement by a convex lens, a video image enlarged by a convex lens is highly grainy, resulting in an inadequately detailed image and poor user experience.

The technical solution provided by the present disclosure uses prism reflection to separately reflect the images on a left eye display screen and a right eye display screen to a user's left eye and right eye to achieve three-dimensional display effects, the enlargement and distortion of the images on the display screens may be avoided because the use of a convex lens is avoided, which may ensure higher clarity, contrast, and brightness of the video image viewed by the user, thus improving user experience.

In order to make the aforementioned purposes, characteristics, and advantages of the present disclosure more evident and easier to understand, detailed descriptions of exemplary embodiments of the present disclosure are provided below with reference to the drawings attached.

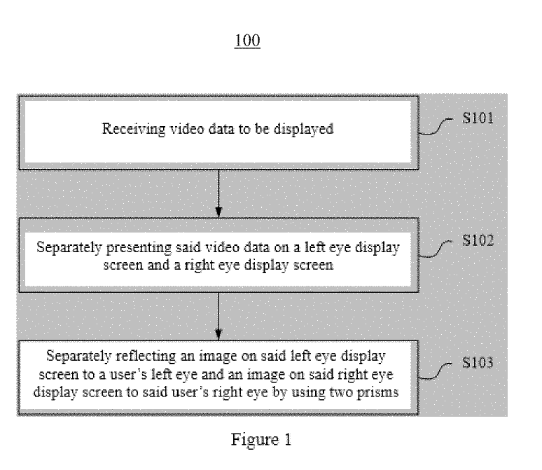

FIG. 1 is a flowchart illustrating a virtual reality display method 100, according to an exemplary embodiment of the present disclosure.

The virtual reality display method 100 includes: Step S101: receiving video data to be displayed; Step S102: separately presenting the video data on a left eye display screen and a right eye display screen; and Step S103: separately reflecting an image on the left eye display screen to a user's left eye and an image on the right eye display screen to the user's right eye by using two prisms.

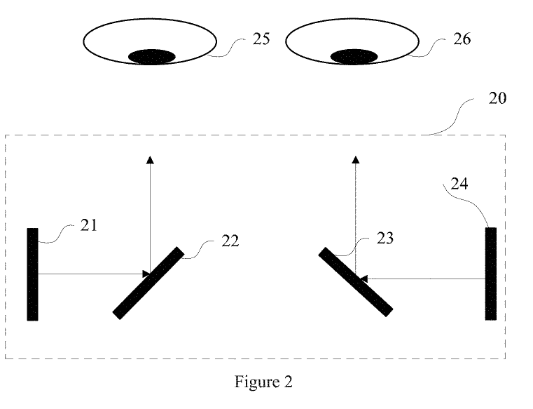

In the present exemplary embodiment, a detailed explanation of the virtual reality display method 100 will be illustrated with reference to the structure of virtual reality glasses 20 illustrated in FIG. 2.

In one embodiment of Step S101, the virtual reality glasses 20 receive video data to be displayed. The video data to be displayed may be received by any implementable means. Specifically, the video data may be received by means of a wireless method, e.g., Bluetooth, wireless network (WLAN), Zigbee protocol, etc.; the video data may also be received by utilizing a wired method, e.g., the video data is received by means of a data interface configured in the virtual reality glasses 20.

In one embodiment of Step S102, the video data is presented separately on a left eye display screen 24 and a right eye display screen 21. Specifically, the video data may comprise frame data, wherein the frame data presented on the left eye display screen 24 and the frame data presented on the right eye display screen 21 are the same.

In one embodiment of Step S103, the image on the left eye display screen 24 is reflected to the user's left eye 26 using a prism 23, and the image on the right eye display screen 21 is reflected to the user's right eye 25 using a prism 22. The present example embodiment separately reflects the images on the display screens to a person's eyes by means of prisms so that the user's left eye and right eye view independent and separate images, thus achieving three-dimensional display effects.

Therefore, during the entire process of the virtual reality display method 100, the images viewed by the user's eyes are obtained by means of prism reflection, which avoids the enlargement and distortion of the images on the display screens caused by convex lenses in currently available technology and may ensure higher clarity, contrast, and brightness of the video image viewed by the user, thus improving user experience.

In one example embodiment of the present disclosure, the number of pixels on the left eye display screen and the number of pixels on the right eye display screen are greater than a preset threshold value.

In the present example embodiment, the number of pixels on the left eye display screen and the number of pixels on the right eye display screen may be configured to be greater than the preset threshold value to further improve the clarity of the image viewed by the user. Specifically, the preset threshold value may be 1800 ppi.

Furthermore, the left eye display screen and the right eye display screen may be provided as molecular organic light-emitting diode displays.

Due to its higher resolution and larger number of pixels, a molecular organic light-emitting diode display may enable the user to view higher-resolution images that have a larger number of pixels, e.g., achieving a resolution of 1920×1080 pixels and an image detail of 3140 ppi, thus further enhancing the user's viewing experience and sense of immersion.

Moreover, images presented on the left eye display screen and the right eye display screen in the present exemplary embodiment are reflected to the user's left eye and right eye by means of prisms rather than directly projected to the person's eyes. In some embodiments, the left eye display screen and the right eye display screen are both smaller in size, thus display screens that have a greater number of pixels may be used. This may lower the cost of virtual reality glasses while at the same time enhance the clarity of images on virtual reality displays.

In another exemplary embodiment of the present disclosure, the sizes of the reflective surfaces of the prisms and the sizes of the left eye display screen and the right eye display screen are all the same.

In one exemplary embodiment of the present disclosure, the sizes of the reflective surfaces of the prisms and the sizes of the display screens are all configured to be the same so that the prisms may reflect the entire images on the display screens to the user's left eye and right eye. Moreover, the images received by the user's eyes by means of the prisms may be ensured to fully cover the reflective surfaces of the prisms because the sizes of the two are the same, thus avoiding the appearance of black borders around the images viewed by the user's eyes and further enhancing the user's viewing experience.

In one embodiment of Step S101 illustrated in FIG. 1, the video data may be received by means of short-range wireless communication.

In the present exemplary embodiment, the virtual reality glasses 20 illustrated in FIG. 2 may interact with other devices by means of short-range wireless communication to receive the video data. That is, obtaining video data on the basis of short-range interaction may avoid the configuration of a storage device, a video generating data device, etc., within the virtual reality glasses. Thus the cost of virtual reality glasses may be lowered while the complexity of the virtual reality glasses is lowered at the same time.

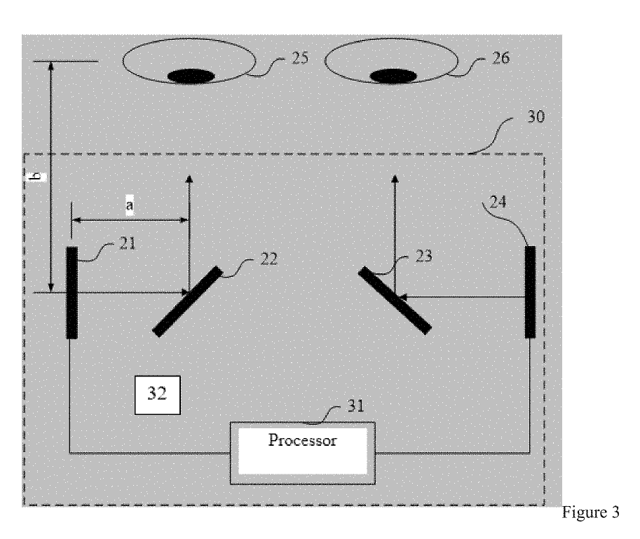

With reference to FIG. 3, a detailed explanation of virtual reality glasses 30 is provided below.

The virtual reality glasses 30 illustrated in FIG. 3 include a processor 31, a left eye display screen 24, a right eye display screen 21, a prism 22, and a prism 23.

Here, the processor 31 is configured to receive video data to be displayed. The left eye display screen 24 and the right eye display screen 21 are configured to separately display the video data. The prism 23 and the prism 22 are configured to separately reflect an image on the left eye display screen 24 to a user's left eye 26 and an image on the right eye display screen 21 to the user's right eye 25.

In one embodiment, the processor 31 may include a memory chip used to cache video data and an audio chip used to process and play audio data in the video data.

The processor 31 may receive video data sent from a terminal device, e.g., a mobile phone, a tablet computer, a computer, etc. After the video data has been decoded, it is separately transmitted to the left eye display screen 24 and the right eye display screen 21 to be displayed.

Further, the processor 31 may further convert the video data into a format configured to be displayed on the left eye display screen 24 and the right eye display screen 21 to ensure that the left eye display screen 24 and the right eye display screen 21 can play the video data normally.

In one embodiment, the relative position and distance between the prism 22 and the right eye display screen 21 may be adaptively configured. For example, the right eye display screen 21 is parallel to the direction of a person's eyes (i.e., the direction of the line of vision) and placed at the right side of the face. The distance between the center of the inclined surface of the prism 22 and the center of the right eye display screen 21 is the horizontal distance between the right side of the face and the center of the eyeball of the right eye 25 (distance “a” in FIG. 3). The light of the right eye display screen 21 is perpendicular to the direction of the person's eyes. After being reflected 90 degrees by the prism 22, the light is reflected to the right eye 25 in a direction parallel to the person's eyes, and the right eye 25 may view an image on the right eye display screen 21. Similarly, the left eye display screen 24 is parallel to the direction of the person's eyes (i.e., the direction of the line of vision) and placed at the left side of the face. The distance between the center of the inclined surface of the prism 23 and the center of the left eye display screen 24 is the horizontal distance between the left side of the face and the center of the eyeball of the left eye 26 (distance “a” in FIG. 3). The light of the left eye display screen 24 is perpendicular to the direction of the person's eyes. After being reflected 90 degrees by the prism 23, the light is reflected to the left eye 26 in a direction parallel to the person's eyes, and the left eye 26 may view an image on the left eye display screen 24.

The vertical distance between the right eye display screen 21 and the right eye 25 (distance “b” in FIG. 3) and the vertical distance between the left eye display screen 24 and the left eye 26 (distance “b” in FIG. 3) may be a preset value, the magnitude of which may ensure that the person's eyes are able to clearly view the full images on the display screens. The preset value may be an empirical value.

In one embodiment, the number of pixels on the left eye display screen 24 and the number of pixels on the right eye display screen 21 is greater than a preset threshold value.

The virtual reality glasses 30 may also include a wireless communication module 32 configured to receive the video data by means of short range wireless communication.

Specifically, the wireless communication module may be a WiFi module or Bluetooth module and may interact with other devices to obtain video data.

In one exemplary embodiment of the present disclosure, the sizes of the reflective surfaces of the prism 23 and the prism 22 and the sizes of the left eye display screen 24 and the right eye display screen 21 are all the same.

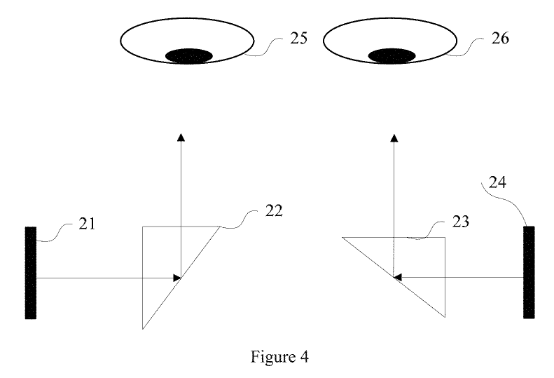

Referring to FIG. 4, in one embodiment of the present disclosure, the prism 23 and prism 22 may be right angle prisms. The reflective surfaces of the prism 23 and the prism 22 are the inclined surfaces of the right-angle prisms. Specifically, the light of the right eye display screen 21 is reflected 90 degrees to the right eye 25 by the inclined surface of the prism 22. The light of the left eye display screen 24 is reflected 90 degrees to the left eye 26 by the inclined surface of the prism 23.

Given the properties of the critical angle in a right-angle prism, total internal reflection may occur to incident light, efficiently reflecting images on the display screens to the person's eyes, thus enhancing the clarity of the images viewed by the person's eyes. Moreover, right angle prisms themselves have larger contact areas and typical angles (45 degrees, 90 degrees). In comparison with other reflective mirrors, right angle prisms are easier to install and exhibit better stability and strength in response to mechanical stress, thus allowing for more complex installation and improved performance of the virtual reality glasses.

The prism 23 and the prism 22 may also be prisms of any other shape or a combination of prisms of at least two shapes to ensure that the light of the display screens can be reflected to the person's eyes. No limitation in this respect is imposed by example embodiments of the present disclosure.

Please refer to the relevant descriptions in FIG. 1 and FIG. 2 for more information on the principles and ways of operation for the virtual reality glasses 30.

In comparison with currently available technology, the technical solution provided by example embodiments of the present disclosure has the following benefits:

The technical solution provided by the present disclosure receives video data to be displayed; separately presents the video data on a left eye display screen and a right eye display screen; and separately reflects an image on the left eye display screen to a user's left eye and an image on the right eye display screen to the user's right eye by using two prisms. The technical solution provided by the present disclosure uses prism reflection to separately reflect the images on the left eye display screen and right eye display screen to the user's left eye and right eye to achieve three-dimensional display effects; the enlargement and distortion of the images on the display screens may be avoided because the use of a convex lens is avoided, which may ensure higher clarity, contrast, and brightness of video images viewed by the user, thus improving user experience.

Further, the sizes of the reflective surfaces of the prisms and the sizes of the left eye display screen and the right eye display screen are all the same. The technical solution of the present disclosure configures the sizes of the reflective surfaces of the prisms and the sizes of the display screens to be all the same so that the prisms may fully reflect the images on the display screens to the user's left eye and right eye; moreover, the images received by the user's eyes by means of the prisms may be ensured to fully cover the reflective surfaces of the prisms because the sizes of the two are the same, thus avoiding the appearance of black borders around the images viewed by the user's eyes and further enhancing the user's viewing experience.

Further, the left eye display screen and the right eye display screen are molecular organic light-emitting diode displays. In the technical solution provided by the present disclosure, due to its higher resolution and larger number of pixels, a molecular organic light-emitting diode display may enable the user to view higher-resolution images that have a larger number of pixels, e.g., achieving a resolution of 1920×1080 pixels and an image detail of 3140 pixels per inch (ppi), thus further enhancing the user's viewing experience and sense of immersion.

Notwithstanding the above disclosure, the present disclosure is not limited thereby. Any person having ordinary skill in the art may make various alterations and changes that are not detached from the essence and scope of the present disclosure; therefore, the scope of protection for the present invention should be that as defined by the claims.

What is claimed is:

1. A virtual reality display method performed by a processor the method comprising:
receiving video data to be displayed;
separately presenting the video data on a left eye display screen and a right eye display screen; and
separately reflecting an image on the left eye display screen to a user's left eye and an image on the right eye display screen to the user's right eye by using two prisms.

2. The virtual reality display method of claim 1, wherein a number of pixels on the left eye display screen and a number of pixels on the right eye display screen are greater than a preset threshold value.

3. The virtual reality display method of claim 1, wherein reflective surfaces of the prisms, the left eye display screen, and the right eye display screen are the same size.

4. The virtual reality display method of claim 1, wherein the receiving video data to be displayed comprises:
receiving the video data by means of short-range wireless communication.

5. The virtual reality display method of claim 1, wherein the left eye display screen and the right eye display screen are molecular organic light-emitting diode displays.

6. Virtual reality glasses, comprising:
a processor configured to receive video data to be displayed;
a left eye display screen and a right eye display screen configured to separately display the video data; and
two prisms configured to separately reflect an image on the left eye display screen to a user's left eye and an image respectively on the right eye display screen to the user's right eye.

7. The virtual reality glasses of claim 6, wherein a number of pixels on the left eye display screen and a number of pixels on the right eye display screen are greater than a preset threshold value.

8. The virtual reality glasses of claim 6, wherein reflective surfaces of the prisms, the left eye display screen, and the right eye display screen are the same size.

9. The virtual reality glasses of claim 6, wherein the left eye display screen and the right eye display screen are molecular organic light-emitting diode displays.

10. The virtual reality glasses of claim 6, wherein the virtual reality glasses comprise a wireless communication module configured to receive the video data by means of short-range wireless communication.

11. The virtual reality glasses of claim 6, wherein the processor converts the video data into a format configured to be displayed on the left eye display screen and the right eye display screen.
